(19) United States
(12) Patent Application Publication
(10) Pub. No.: US 2019/0276157 A1
(43) Pub. Date: Sep. 12, 2019

(54) FLEXIBLE RADIAL INLET PLENUM

(71) Applicant: Bell Helicopter Textron Inc., Fort Worth, TX (US)

(72) Inventors: Marc Ouellet, Sainte-Sophie (CA); Guillaume Noiseux-Boucher, Mirabel (CA)

(73) Assignee: Bell Helicopter Textron Inc., Fort Worth, TX (US)

(21) Appl. No.: 15/915,632

(22) Filed: Mar. 8, 2018

(51) Int. Cl. B64D 29/04; B64D 33/02

(52) U.S. Cl. CPC B64D 29/04; B64C 27/06; B64D 33/02

(57) ABSTRACT

A radial inlet plenum a forward panel, an aft panel, and a cowling extending therebetween. The forward and aft panels are coupled between the cowling and an engine. The forward and aft panels include flexible sections to allow the engine to translate radially and axially, as well as rotate, relative to the cowling.

### BACKGROUND

Rotorcraft generally have their main rotor gearbox tilt to control the attitude, orientation, and direction of the rotorcraft. However, the engine that provides torque to the main rotor gearbox is usually rigidly coupled to the airframe. Therefore, the relative motion between the main rotor gearbox and the engine is absorbed by flexible couplings between the engine and the main rotor gearbox. In this conventional configuration, a rigid radial inlet is used. The rigid radial inlet typically comprises two parallel, rigid, usually metallic, plates. Unfortunately, the flexible couplings utilized in the driveline are an expensive component and have limited lifespans. Accordingly, it may be desirable to remove the flexible couplings from the driveline and rigidly couple the engine output to the main rotor gearbox. However, rigid coupling of the engine output and main rotor gearbox would require the engine to be able to move with the gearbox relative to the airframe. In this rigidly coupled configuration, a rigid inlet plenum cannot be used because the motion of the engine would cause gaps in the rigid plenum, allowing unfiltered and/or hot air into the engine intake. Thus, a new, flexible inlet plenum is required.

### BRIEF DESCRIPTION OF THE DRAWINGS

FIG. 1 is a side view of a rotorcraft including a flexible radial inlet plenum, according to this disclosure.

FIG. 2 is an oblique view of an engine and the flexible radial inlet plenum of FIG. 1.

FIG. 3 is a side view of the engine and flexible radial inlet plenum of FIG. 1 with some internal components shown with dashed lines.

FIG. 4 is an oblique view of the engine and flexible radial inlet plenum of FIG. 1 with a cowling shown as partially transparent, so the interior of the flexible radial inlet plenum is viewable.

FIG. 5 is a front view of the engine and flexible radial inlet plenum of FIG. 1.

FIG. 6 is a rear view of the engine and flexible radial inlet plenum of FIG. 1.

FIG. 7 is a top view of the engine and flexible radial inlet plenum of FIG. 1 with the cowling shown as partially transparent, so the interior of the flexible radial inlet plenum is viewable.

FIG. 8 is a side view of the engine showing the flexible radial inlet plenum of FIG. 1 in cross-section.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure divulges a flexible radial inlet plenum. The flexible radial inlet plenum includes a flexible fireproof material on both sides of the inlet plenum. The flexible material extends between a cowling coupled to an exterior of the aircraft and a rigid inner frame coupled to the engine. While the flexible radial inlet plenum includes material that is flexible, the freedom of radial, axial, and rotational movement of the rigid inner frame relative to the cowling is preferably provided by a funnel shape and/or overlapping of the flexible material extending between the inner frame and the cowling.

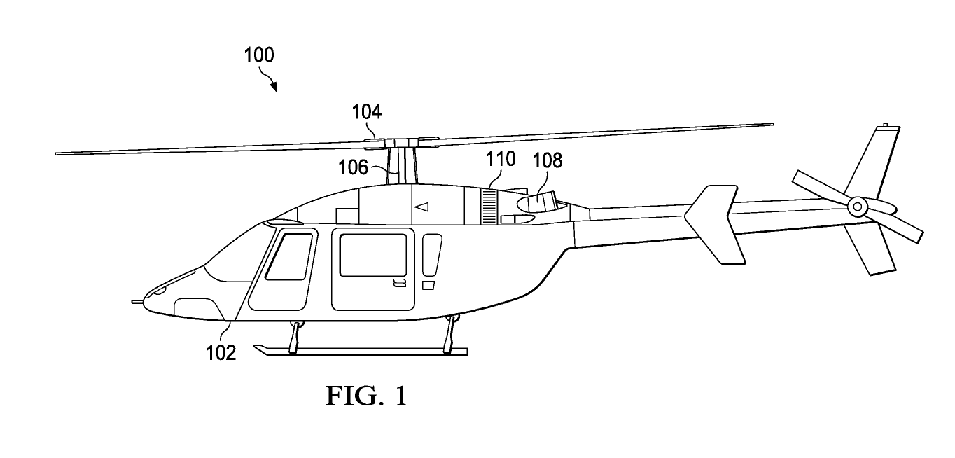

FIG. 1 illustrates a rotorcraft 100 including a fuselage 102, a rotor 104, a rotor mast 106, an engine 108, and a flexible radial inlet plenum 110. Engine 108 is rigidly coupled to a main rotor gearbox (not shown), which is coupled to rotor mast 106, which is coupled to rotor 104. Accordingly, the forces experienced by rotor 104 affect movement of engine 108 relative to fuselage 102. Flexible radial inlet plenum 110 is rigidly coupled between fuselage 102 and engine 108. Thus, flexible radial inlet plenum 110 accommodates the relative movement between engine 108 and fuselage 102.

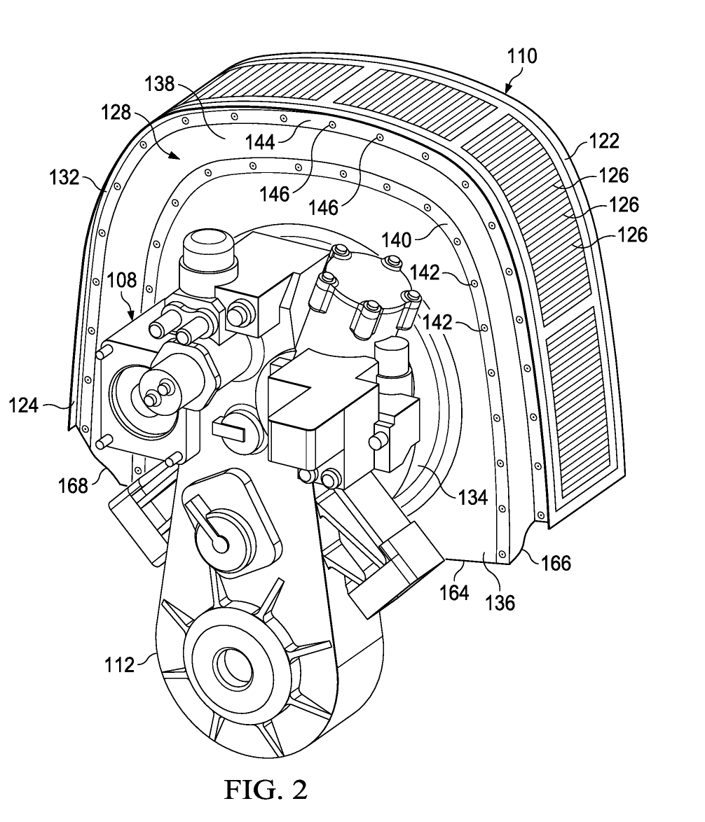

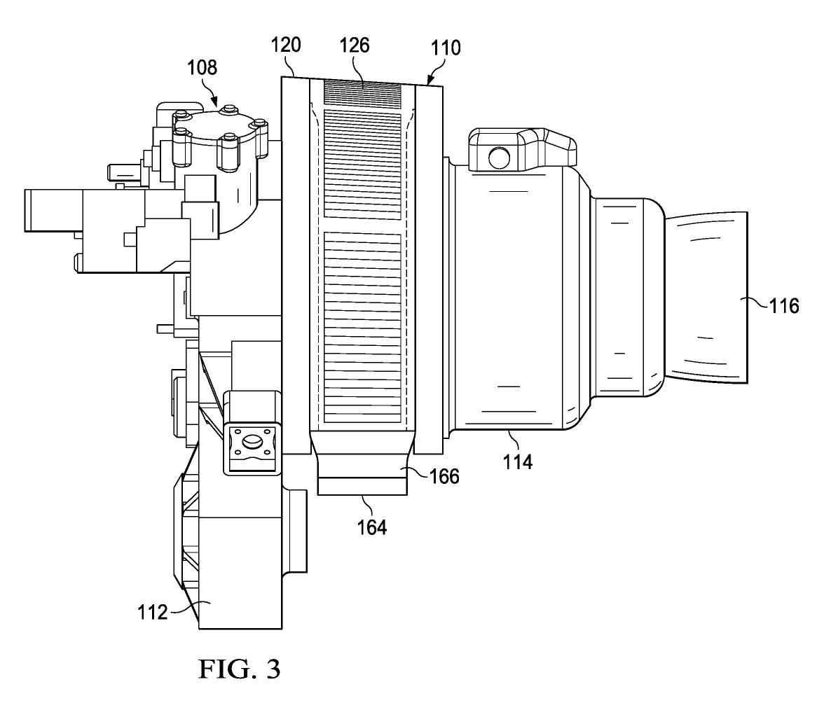

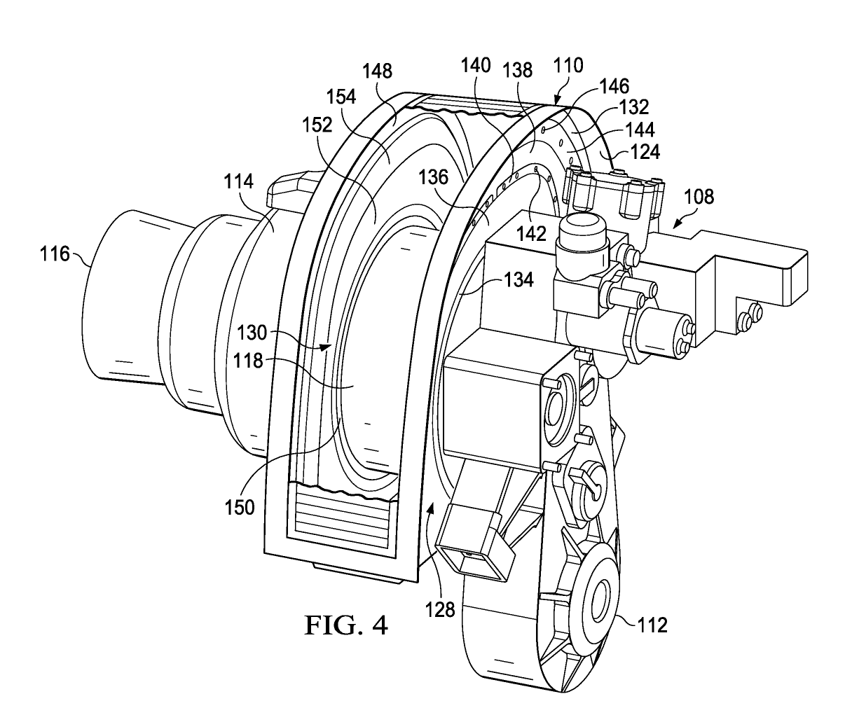

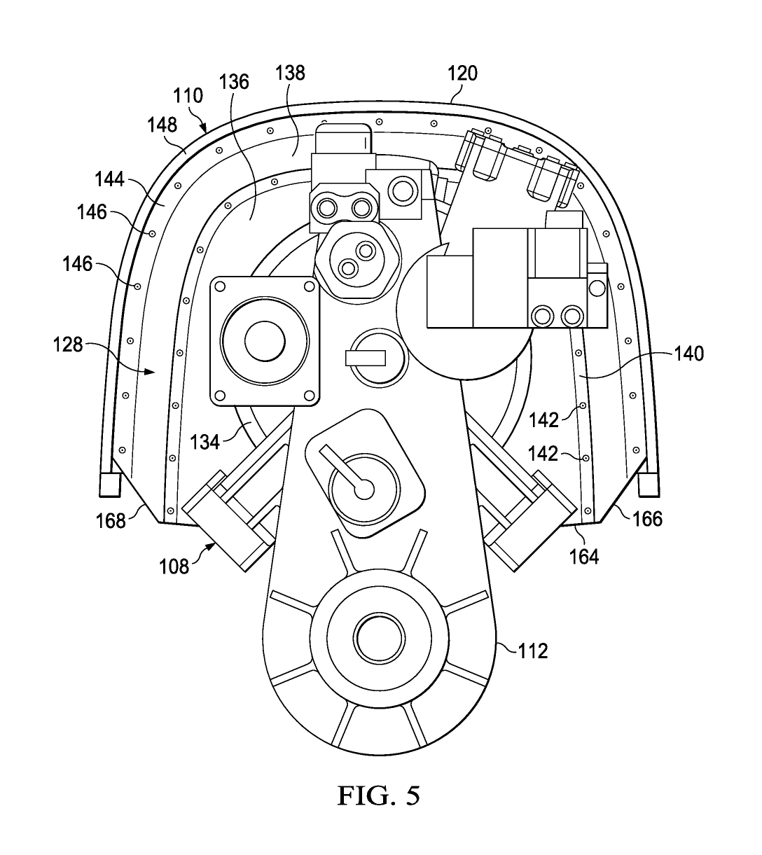

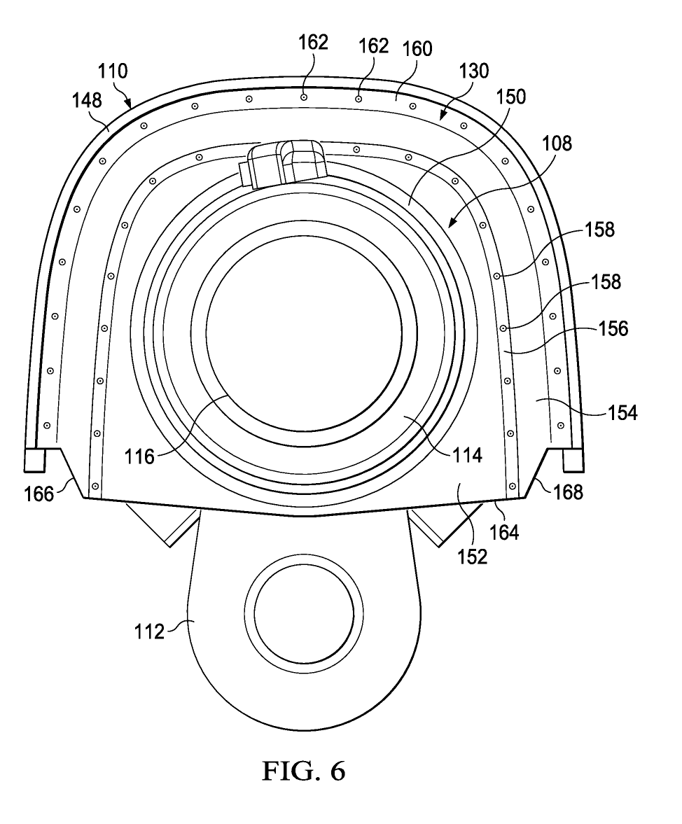

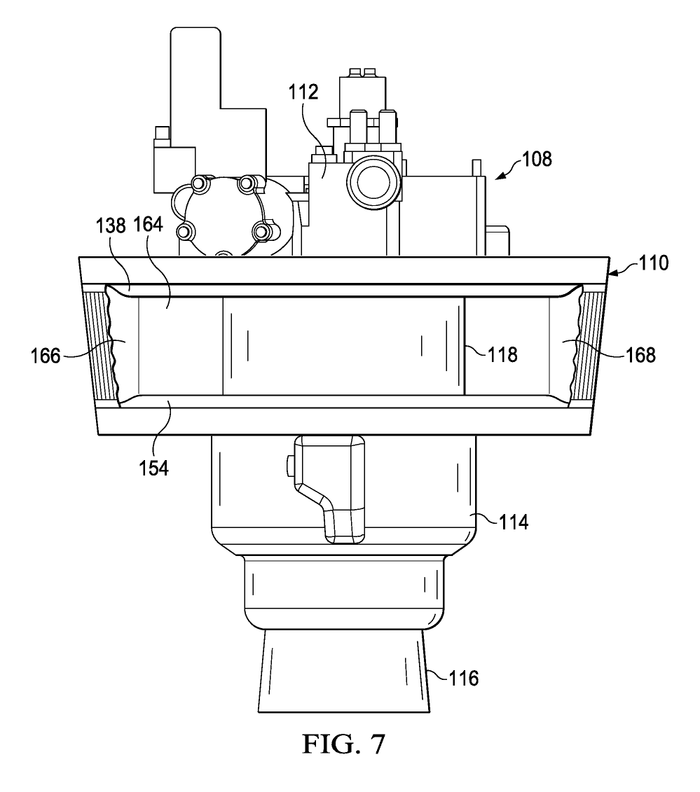

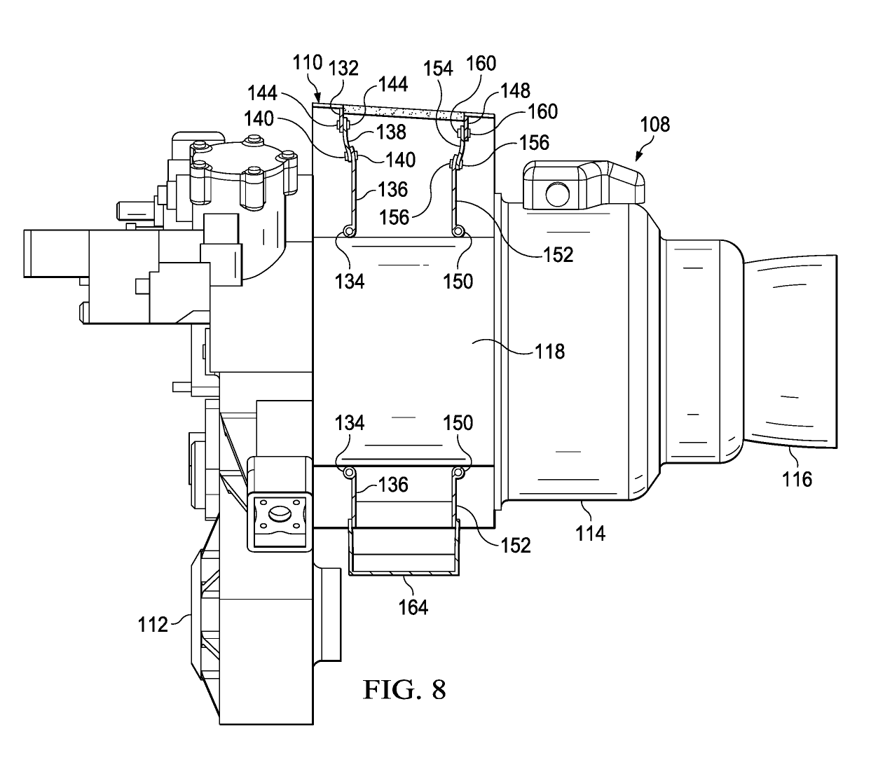

FIGS. 2-8 illustrate flexible radial inlet plenum 110 in conjunction with engine 108. Engine 108 includes an engine gearbox 112, a combustion chamber 114, and an exhaust 116. A radial air intake 118 is located between engine gearbox 112 and combustion chamber 114. Radial air intake 118 feeds air from flexible radial inlet plenum 110 into combustion chamber 114. Because radial air intake 118 is adjacent to combustion chamber 114 and exhaust 116, it is imperative that flexible radial inlet plenum 110 provide a sufficient barrier between radial air intake 118 and combustion chamber 114 so that no hot air enters radial air intake 118.

Flexible radial inlet plenum 110 includes a cowling 120 having an exterior surface 122, an opposite interior surface 124, and a plurality of openings 126 extending between exterior surface 122 and interior surface 124. Exterior surface 122 of cowling 120 has a generally arcuate shape that mimics the shape of fuselage 102. Exterior surface 122 is substantially flush with a portion of fuselage 102 surrounding cowling 120. Openings 126 are configured to allow cool air from outside fuselage 102 to pass through cowling 120 into flexible radial inlet plenum 110 where it may be compressed prior to entering radial air intake 118. Interior surface 124 of cowling 120 is configured to position filter elements (not shown), such as a paper barrier filter, screen, or particle separator, against plurality of openings 126 to prevent any debris from entering radial air intake 118. Cowling 120 may be made of carbon fiber, aluminum, titanium, or any other suitable material.

Flexible radial inlet plenum 110 includes a forward panel 128 adjacent to engine gearbox 112 and an aft panel 130 adjacent to combustion chamber 114. The outermost portion of forward panel 128 is a forward outer flange 132 that extends radially inward from, and is rigidly coupled to, interior surface 124 of cowling 120. The innermost portion of forward panel 128 is a forward inner frame 134 that is sized and shaped to fit around a portion of engine 108 between engine gearbox 112 and radial air intake 118. Optionally, a P-seal (not shown) may be coupled between forward inner frame 134 and engine 108 to absorb small vibrations therebetween. A rigid forward planar section 136 extends radially outward from forward inner frame 134. Forward planar section 136 is substantially parallel to forward outer flange 132. However, forward planar section 136 and forward inner frame 134 are longitudinally offset from forward outer flange 132. Forward planar section 136 may be an extension of forward inner frame 134 or it may be a separate component coupled thereto. Forward inner frame 134, forward outer flange 132, and forward planar section 136 may be made of carbon fiber, aluminum, titanium, or any other suitable material.

A forward flexible section 138 extends from forward planar section 136 (or forward inner frame 134) to forward outer flange 132. Forward flexible section 138 is made of a flexible, fireproof material, such as fiberglass, or carbon fiber, reinforced silicone. The material comprising forward flexible section 138 overlaps forward planar section 136 and forward outer flange 132. The portion of the material comprising forward flexible section 138 that overlaps forward planar section 136 is sandwiched between forward planar section 136 and a forward inner retainer 140. And forward inner retainer 140 is coupled to forward planar section 136 by a plurality of fasteners 142. The portion of the material that comprises forward flexible section 138 that overlaps forward outer flange 132 is sandwiched between forward outer flange 132 and a forward outer retainer 144. And forward outer retainer 144 is attached to forward outer flange 132 by a plurality of fasteners 146. Fasteners 142 and 146 may be screws, bolts, rivets, pins, or any other suitable fastener. Alternatively, the overlapping portions of forward flexible section 138 may be coupled to forward planar section 136 and forward outer flange 132 using an adhesive. Forward flexible section 138 may be generally funnel shaped. The funnel shape of forward flexible section 138 is caused by forward outer flange 132 being longitudinally further from radial air intake 118 than forward planar section 136. Accordingly, forward flexible section 138 generally slopes toward radial air intake 118 from forward outer flange 132 to forward planar section 136. However, while the funnel shape may be taut, it is preferably loose, having a sloping S or Z shaped cross-section, or an accordion-type fold so that a portion of forward flexible section 138 may fold over on itself when engine 108 is in a static position. This configuration will allow forward flexible section 138 to deform when engine 108 moves, without stretching the material.

Similar to forward panel 128, the outermost portion of aft panel 130 is an aft outer flange 148 that extends radially inward from, and is rigidly coupled to, interior surface 124 of cowling 120. The innermost portion of aft panel 130 is an aft inner frame 150 that is sized and shaped to fit around a portion of engine 108 between combustion chamber 114 and radial air intake 118. Optionally, a P-seal (not shown) may be coupled between aft inner frame 150 and engine 108 to absorb small vibrations therebetween. Extending radially outward from aft inner frame 150 is a rigid aft planar section 152. Aft planar section 152 is substantially parallel to aft outer flange 148. However, aft planar section 152 and aft inner frame 150 are longitudinally offset from aft outer flange 148. Aft planar section 152 may be an extension of aft inner frame 150 or it may be a separate component coupled thereto. Aft inner frame 150, aft outer flange 148, and aft planar section 152 may be made of carbon fiber, aluminum, titanium, or any other suitable material.

An aft flexible section 154 extends from aft planar section 152 (or aft inner frame 150) to aft outer flange 148. Aft flexible section 154 is made of a flexible, fireproof material, such as fiberglass, or carbon fiber, reinforced silicone. The material comprising aft flexible section 154 overlaps aft planar section 152 and aft outer flange 148. The portion of the material comprising aft flexible section 154 that overlaps aft planar section 152 is sandwiched between aft planar section 152 and an aft inner retainer 156. And aft inner retainer 156 is coupled to aft planar section 152 by a plurality of fasteners 158. The portion of the material that comprises aft flexible section 154 that overlaps aft outer flange 148 is sandwiched between aft outer flange 148 and an aft outer retainer 160. And aft outer retainer 160 is attached to aft outer flange 148 by a plurality of fasteners 162. Fasteners 158 and 162 may be screws, bolts, rivets, pins, or any other suitable fastener. Alternatively, the overlapping portions of aft flexible section 154 may be coupled to aft planar section 152 and aft outer flange 148 using an adhesive. Aft flexible section 154 may be generally funnel shaped. The funnel shape of aft flexible section 154 is caused by aft outer flange 148 being longitudinally further from radial air intake 118 than aft planar section 152. Accordingly, aft flexible section 154 generally slopes toward radial air intake 118 from aft outer flange 148 to aft planar section 152. However, while the funnel shape may be taut, it is preferably loose, having a sloping S or Z shaped cross-section, or an accordion-type fold so that a portion of aft flexible section 154 may fold over on itself when engine 108 is in a static position. This configuration will allow aft flexible section 154 to deform when engine 108 moves, without stretching the material.

Flexible radial inlet plenum 110 further includes a rigid bottom plate 164 extending from a bottom of forward planar section 136 to a bottom of aft planar section 152. Bottom plate 164 is coupled to cowling 120 in a similar manner as forward planar section 136 and aft planar section 152. That is, a port flexible section 166 is coupled between bottom plate 164 and a port flange (not shown) that extends radially inward from, and is coupled to, interior surface 124 of cowling 120. Port flexible section 166 is coupled to bottom plate 164 and the port flange with a pair of retainers (not shown) fastened to bottom plate 164 and the port flange, respectively. Similarly, a starboard flexible section 168 is coupled between bottom plate 164 and a starboard flange (not shown) that extends radially inward from, and is coupled to, interior surface 124 of cowling 120. Starboard flexible section 168 is coupled to bottom plate 164 and the starboard flange with a pair of retainers (not shown) fastened to bottom plate 164 and the starboard flange, respectively. Port flexible section 166 and starboard flexible section 168 may be coupled to forward flexible section 138 and aft flexible section 154 using hook and loop fasteners, zippers, adhesive, or they may be sewn together.

While bottom plate 164 is shown and described above as being directly coupled to forward planar section 136 and aft planar section 152, it should be understood that forward flexible section 138 and aft flexible section 154 may extend all the way around forward planar section 136 and aft planar section 152, respectively. In this configuration, forward flexible section 138 and aft flexible section 154 would be coupled to bottom plate 164 in a similar manner as they are coupled to cowling 120.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A radial inlet plenum, comprising:
a cowling having an exterior surface that is at least in part arcuate and an opposite interior surface, the cowling defining a plurality of openings extending from the exterior surface to the interior surface;
a forward outer flange extending radially inward from the interior surface of the cowling;
an aft outer flange extending radially inward from the interior surface of the cowling;
a forward inner frame configured to be coupled to an engine;
an aft inner frame configured to be coupled to the engine;
a forward flexible section configured to be coupled between the forward outer flange and the forward inner frame; and
an aft flexible section configured to be coupled between the aft outer flange and the aft inner frame.

2. The radial inlet plenum of claim 1, wherein the forward outer flange is axially offset from the forward inner frame and the aft outer flange is axially offset from the aft inner frame.

3. The radial inlet plenum of claim 2, wherein a material comprising the forward flexible section overlaps with the forward outer flange and the forward inner frame and a material comprising the aft flexible section overlaps with the aft outer flange and the aft inner frame.

4. The radial inlet plenum of claim 3, further comprising:
a forward outer retainer configured to couple the material comprising the forward flexible section to the forward outer flange;
a forward inner retainer configured to couple the material comprising the forward flexible section to the forward inner frame;
an aft outer retainer configured to couple the material comprising the aft flexible section to the aft outer flange; and
an aft inner retainer configured to couple the material comprising the aft flexible section to the aft inner frame.

5. The radial inlet plenum of claim 4, wherein a length of the material comprising the forward flexible section between the forward outer flange and the forward inner frame along a cross-sectional plane is longer that a distance between the forward outer flange and the forward inner frame.

6. The radial inlet plenum of claim 5, wherein the material comprising the forward flexible section and the material comprising the aft flexible section are both flexible and fireproof materials.

7. The radial inlet plenum of claim 6, wherein the forward flexible section is folded over on itself.

8. The radial inlet plenum of claim 7, further comprising:
a forward P-seal configured to be coupled between the forward inner frame and the engine; and
an aft P-seal configured to be coupled between the aft inner frame and the engine.

9. A radial inlet plenum, comprising:
a cowling configured to cover at least a portion of a radial air intake of an engine, the cowling having an outer surface, an inner surface, and a plurality of openings extending from the outer surface to the inner surface;
a forward panel coupled to the cowling and configured to be coupled to the engine, the forward panel including a forward flexible section that allows an innermost portion of the forward panel to translate and rotate relative to an outermost portion of the forward panel; and
an aft panel coupled to the cowling and configured to be coupled to the engine, the aft panel including an aft flexible section that allows an innermost portion of the aft panel to translate and rotate relative to an outermost portion of the aft panel.

10. The radial inlet plenum of claim 9, wherein the innermost portion of the forward panel and the innermost portion of the aft panel comprise rigid materials configured to surround portions of the engine.

11. The radial inlet plenum of claim 10, wherein the translation of the innermost portions of the panels relative to the outermost portions of the panels may be up to one-half of an inch and the relative rotation may be up to 2 degrees.

12. The radial inlet plenum of claim 11, wherein the outermost portion of the forward panel comprises a flange rigidly coupled to the interior surface of the cowling.

13. The radial inlet plenum of claim 12, further comprising:
a forward outer retainer configured to couple the forward flexible section to the flange; and
a forward inner retainer configured to couple the forward flexible section to the innermost portion.

14. The radial inlet plenum of claim 13, wherein a length of the forward flexible section between the flange and the innermost portion along a cross-sectional plane is longer than a distance between the flange and the innermost portion.

15. The radial inlet plenum of claim 14, wherein the forward flexible section is folded over on itself.

16. A rotorcraft, comprising:
a fuselage;
an engine;
a gearbox coupled to the engine; and
a radial inlet plenum, comprising:
a cowling having an exterior surface that is substantially flush with a portion of the fuselage surrounding the cowling and an opposite interior surface, the cowling defining a plurality of openings extending from the exterior surface to the interior surface;
a forward outer flange extending radially inward from the interior surface of the cowling;
an aft outer flange extending radially inward from the interior surface of the cowling;
a forward inner frame configured to be coupled to the engine;
an aft inner frame configured to be coupled to the engine;
a forward flexible section configured to be coupled between the forward outer flange and the forward inner frame; and
an aft flexible section configured to be coupled between the aft outer flange and the aft inner frame.

17. The rotorcraft of claim 16, wherein the radial inlet plenum further comprises:
a forward outer retainer configured to couple the material comprising the forward flexible section to the forward outer flange;
a forward inner retainer configured to couple the material comprising the forward flexible section to the forward inner frame;
an aft outer retainer configured to couple the material comprising the aft flexible section to the aft outer flange; and
an aft inner retainer configured to couple the material comprising the aft flexible section to the aft inner frame.

18. The rotorcraft of claim 17, wherein a length of the material comprising the forward flexible section between the forward outer flange and the forward inner frame along a cross-sectional plane is longer than a distance between the forward outer flange and the forward inner frame.

19. The rotorcraft of claim 18, wherein the radial inlet plenum further comprises:
a filter element removably coupled to the interior surface of the cowling.

20. The rotorcraft of claim 19, further comprising:
a forward P-seal coupled between the forward inner frame and the engine; and
an aft P-seal coupled between the aft inner frame and the engine.
